(19) United States
(12) Patent Application Publication
(10) Pub. No.: US 2026/0121172 A1
(43) Pub. Date: Apr. 30, 2026

(54) BATTERY ASSEMBLY AND METHOD OF MANUFACTURING THE SAME

(71) Applicant: SK On Co., Ltd., Seoul (KR)

(72) Inventor: Hyun Seok KIM, Daejeon (KR)

(21) Appl. No.: 19/312,331

(22) Filed: Aug. 28, 2025

(30) Foreign Application Priority Data
Oct. 30, 2024 (KR) 10-2024-0150875

(51) Int. Cl. H01M 10/658; H01M 10/647; H01M 50/211; H01M 50/262; H01M 50/271; H01M 50/293

(52) U.S. Cl. CPC H01M 10/658; H01M 10/647; H01M 50/211; H01M 50/262; H01M 50/271; H01M 50/293

(57) ABSTRACT

The present disclosure relates to a battery assembly and a manufacturing method thereof. The battery assembly manufactured by the manufacturing method includes a bottom plate, a side plate forming a receiving space with the bottom plate, a plurality of battery cells stacked and disposed in the receiving space, a top plate sealing the receiving space, and a plurality of thermal barrier members disposed in the receiving space, wherein at least one of the plurality of thermal barrier members is disposed such that a gap between the engagement plate and the plurality of thermal barrier members is prevented from occurring.

### CROSS-REFERENCE TO RELATED PATENT APPLICATION

The present application claims priority under 35 U.S.C. § 119 (a) to Korean patent application number 10-2024-0150875 filed on Oct. 30, 2024 in the Korean Intellectual Property Office, the entire disclosed portion of which is incorporated by reference herein.

### BACKGROUND OF THE INVENTION

### 1. Field

The present disclosure relates to a battery assembly and a method of manufacturing the same, and more particularly, to a battery assembly and a method of manufacturing the battery assembly that can prevent a gap from occurring between a plate forming an exterior of the battery assembly and a thermal barrier member.

### 2. Description of the Related Art

A battery cell includes an electrode assembly in which a cathode plate and an anode plate applied with a cathode active material and an anode active material, respectively, are arranged with a separator therebetween, and an exterior member sealing and accommodating the electrode assembly together with an electrolyte.

Recently, the increasing need for high-capacity structures, including their use as energy storage sources, has led to a growing demand for battery assemblies, such as a plurality of battery cells electrically connected in series and/or in parallel, battery modules housing such cells, and battery management systems (BMSs).

A battery assembly typically has an outer housing made of metal to protect the plurality of battery cells from external impact or to house and store the battery cells. However, in the event that a battery cell housed inside the battery assembly ignites or explodes, heat or flame may be transferred to neighboring battery cells, causing a secondary explosion or the like.

To avoid this, the battery assembly may be configured such that when a battery cell undergoes thermal runaway, the gas generated by the thermal runaway is discharged only through a hole formed at a predetermined location, and the transfer of heat between the battery cell and the adjacent battery cell is blocked.

By way of example, the battery assembly may include a thermal barrier member capable of blocking the transfer of heat between the battery cell and adjacent battery cells. The thermal barrier member is coupled to the housing of the battery assembly without gaps to prevent the transfer of gases having a high temperature and pressure from the ignited or exploded battery cell to the adjacent battery cells, thereby preventing the spread of heat.

However, it may occur that the pressure of gases from the thermally exploded battery cell causes at least one of a bottom plate, a side plate, and a top plate forming the housing of the battery assembly to be moved or repositioned in a direction away from the thermal barrier member.

As such, when at least one or more of the bottom plate, the side plate, and the top plate is moved or changed in position, a gap is created between the housing and the thermal barrier member, and the gap causes gases generated from the thermally exploded battery cell to migrate to the adjacent battery cells to spread heat.

Thus, the bottom plate, the side plate, and the top plate constituting the housing may be increased in thickness to prevent changes in the position of the housing of the battery assembly. However, the increase in the thickness of each of the bottom plate, the side plate, and the top plate results in an increase in the weight of the battery assembly.

Therefore, it is necessary to develop a relatively lightweight battery assembly that can prevent heat from spreading to adjacent battery cells when a thermal runaway phenomenon occurs in a battery cell included in the battery assembly.

### SUMMARY OF THE INVENTION

An aspect of the present disclosure is to provide a battery assembly capable of preventing gases generated by a battery cell received in the battery assembly, when the battery cell undergoes thermal runaway, from migrating to other adjacent battery cells.

Another aspect of the present disclosure is to provide a relatively lightweight battery assembly.

A battery assembly and a manufacturing method thereof according to the present disclosure may be widely applied in the fields of green technology using batteries such as electric vehicles. In addition, the battery assembly according to the present disclosure may be used in eco-friendly electric vehicles and hybrid vehicles to prevent climate change by suppressing air pollution and greenhouse fluid emissions.

A battery assembly according to embodiments of the present disclosure may include a bottom plate, a side plate connected to the bottom plate to form a receiving space with the bottom plate, a plurality of battery cells stacked and disposed in a predetermined direction in the receiving space, a top plate coupled to the side plate to seal the receiving space, and a plurality of thermal barrier members each selectively disposed between adjacent battery cells of the plurality of battery cells and disposed in the receiving space to come into close contact with the bottom plate, the side plate, and the top plate, wherein at least one of the plurality of thermal barrier members comprises a fixing portion projecting in a direction toward at least one of the bottom plate, the side plate, and the top plate, and wherein an engagement plate of at least one of the bottom plate, the side plate, and the top plate adjacent to the fixing portion engages with the fixing portion and is prevented from being moved in a direction away from the plurality of thermal barrier members such that a gap between the engagement plate and the plurality of thermal barrier members is prevented from occurring.

A first groove may be provided in the fixing portion in a direction perpendicular to a direction facing the engagement plate, and a second groove may be provided in the engagement plate and at least a portion of the engagement plate may be inserted into the first groove of the fixing portion penetrating the second groove.

The fixing portion may include: a first extension extending in a direction toward the engagement plate, and a second extension connected to one end of the first extension and bent from the first extension to form the first groove between the first extension and the second extension, and when the fixing portion penetrates the second groove, the engagement plate may slide in a direction toward the first groove such that at least a portion of the engagement plate is inserted into the first groove.

A third groove through which the fixing portion passes may be provided in the engagement plate, and after the fixing portion penetrates the third groove, at least a portion of the fixing portion may be bent to come into contact with the engagement plate.

The fixing portion may include: a third extension extending in a direction toward the engagement plate, and a fourth extension rotatably coupled to one end of the third extension, and fixed in position when the fourth extension is rotated from the one end of the third extension to come into contact with the engagement plate.

The engagement plate may include a recessed portion where a fourth groove through which the fixing portion passes is formed, the recessed portion recessed in a direction toward the thermal barrier member, and after the fixing portion penetrates the fourth groove, at least a portion of the fixing portion may be bent to come into contact with the recessed portion.

The fixing portion may include: a fifth extension extending in a direction toward the recessed portion, and a sixth extension rotatably coupled to one end of the fifth extension, and fixed in position when the sixth extension is rotated from the one end of the fifth extension to come into contact with the recessed portion.

A method of manufacturing a battery assembly according to embodiments of the present disclosure may include: preparing a bottom plate, a side plate connected to the bottom plate to form a receiving space with the bottom plate, and a top plate, placing components of the battery assembly in the receiving space, the components including a plurality of battery cells stacked in a predetermined direction and a plurality of thermal barrier members each selectively disposed between adjacent battery cells of the plurality of battery cells, and disposed in the receiving space to come into close contact with the bottom plate, the side plate, and the top plate, and coupling the top plate to the side plate to seal the receiving space, wherein at least one of the plurality of thermal barrier members comprises a fixing portion projecting in a direction toward at least one of the bottom plate, the side plate, and the top plate, and wherein an engagement plate of at least one of the bottom plate, the side plate, and the top plate adjacent to the fixing portion engages with the fixing portion and is prevented from being moved in a direction away from the plurality of thermal barrier members such that a gap between the engagement plate and the plurality of thermal barrier members is prevented from occurring.

A first groove may be formed in the fixing portion in a direction perpendicular to a direction facing the engagement plate, and a second groove through which the fixing portion passes may be formed in the engagement plate, and at least a portion of the fixing portion may be inserted into the first groove of the fixing portion penetrating the second groove.

The fixing portion may include: a first extension extending in a direction toward the engagement plate, and a second extension connected to one end of the first extension, and bent from the first extension to form the first groove between the first extension and the second extension, and the engagement plate may slide in a direction toward the first groove such that at least a portion thereof is inserted into the first groove when the fixing portion penetrates the second groove.

A third groove through which the fixing portion passes may be formed in the engagement plate, and after the fixing portion penetrates the third groove, at least a portion of the fixing portion may be bent to come into contact with the engagement plate.

The fixing portion may include: a third extension extending in a direction toward the engagement plate, and a fourth extension rotatably coupled to one end of the third extension, and fixed in position when the fourth extension is rotated from the one end of the third extension to come into contact with the engagement plate.

A fourth groove through which the fixing portion passes may be formed in the engagement plate in a direction facing the thermal barrier member, and after the fixing portion penetrates the fourth groove, at least a portion of the fixing portion may be bent to come into contact with the recessed portion.

The fixing portion may include: a fifth extension extending in a direction toward the recessed portion, and a sixth extension rotatably coupled to one end of the fifth extension, and fixed in position when the sixth extension is rotated from the one end of the fifth extension to come into contact with the recessed portion.

Specific details of other embodiments for solving the problems are included in the description of the invention and the drawings.

According to the means for solving the problems of the present disclosure, according to the present disclosure, in the battery assembly according to the present disclosure and the manufacturing method thereof, the bottom plate, the side plate, and the top plate are configured to engage with the fixing portion of the thermal barrier member so as to be prevented from being moved in a direction away from the thermal barrier member, so that when a battery cell accommodated in the battery assembly undergoes thermal runaway, gas generated from the battery cell is prevented from being transferred to other adjacent battery cells.

In addition, since the thermal barrier member is configured to prevent the positions of the bottom plate, the side plate, and the top plate from changing by using the fixing portion formed on the thermal barrier member, the bottom plate, the side plate, and the top plate may have a relatively small thickness, thereby reducing the weight of the battery assembly.

### BRIEF DESCRIPTION OF THE DRAWINGS

FIG. 1 is an exploded perspective view of a battery assembly according to one embodiment of the present disclosure;

FIG. 2 is a diagram illustrating a bottom plate and a side plate forming a receiving space;

FIG. 3 is a diagram illustrating a plurality of battery cells and a plurality of thermal barrier members;

FIG. 4 is a diagram illustrating a thermal barrier member having a fixing portion;

FIG. 5 is diagram illustrating a top plate engaged with fixing portions of thermal barrier members;

FIG. 6 is a diagram illustrating a top plate and a fixing portion according to one embodiment before engagement;

FIG. 7 is a diagram illustrating a top plate and a fixing portion according to one embodiment after engagement;

FIG. 8 is a diagram illustrating a top plate and a fixing portion according to another embodiment before engagement;

FIG. 9 is a diagram illustrating a top plate and a fixing portion according to another embodiment after engagement;

FIG. 10 is a diagram illustrating a top plate with a recessed portion and a fixing portion before engagement;

FIG. 11 is a diagram illustrating a top plate with a recessed portion and a fixing portion before engagement; and

FIG. 12 is a flowchart for illustrating a method of manufacturing a battery assembly according to one embodiment of a present disclosure.

### DETAILED DESCRIPTION

Hereinafter, embodiments of the present invention will be described in detail with reference to the accompanying drawings, so that those skilled in the art can readily implement the invention. However, it should be understood that the present invention is not limited to the embodiments set forth herein and may be embodied in various other forms. In the drawings, components that are not directly related to the description of the invention are omitted for clarity, and like reference numerals are used to designate like elements throughout the specification.

Throughout the specification, in a case in which a portion is “connected” to another portion, the case includes not only a case in which the portion is “directly connected” but also a case in which the portion is “indirectly connected” to one or more other elements interposed therebetween.

Throughout the specification, when a part is described as being “on” another part, this encompasses not only cases where the part is directly on the other part, but also cases where one or more intervening elements may be present therebetween.

Throughout the disclosure, the term “include” (or its variants such as “comprise” or “have”) is intended to be inclusive, not exclusive, unless expressly stated otherwise. The term “about” or “substantially,” and similar expressions are intended to allow for reasonable variation due to manufacturing or material tolerances, and is used to assist in the understanding of the present disclosure and to prevent unscrupulous infringers from unfairly taking advantage of the disclosure where precise or absolute numerical values are recited. Furthermore, as used throughout the specification, the term “step of (˜ing)” or “step of ˜” does not mean a “step for.”

Hereinafter, the preferred embodiments of the present disclosure will be described in detail with reference to the accompanying drawings and the description below. However, the present disclosure is not limited to the embodiments described herein and may be embodied in other forms. Throughout the specification, the same reference numerals indicate the same components.

Hereinafter, the configuration of a battery assembly according to an embodiment of the present disclosure will be described.

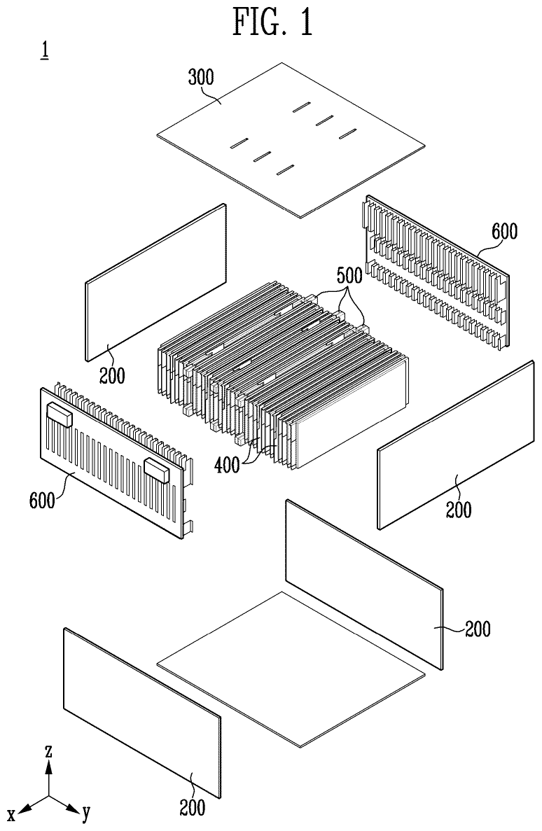

FIG. 1 is an exploded perspective view of a battery assembly 1 according to one embodiment of the present disclosure.

Referring to FIG. 1, the battery assembly 1 may include a bottom plate 100, a side plate 200, a top plate 300, battery cells 400, thermal barrier members 500, and busbar assemblies 600.

First, the bottom plate 100 will be described.

Referring to FIG. 1, the bottom plate 100 may form a lower portion of a housing which forms the exterior of the battery assembly 1, and may be formed in the shape of a plate.

Subsequently, the side plate 200 will be described.

Referring to FIG. 1, the side plate 200 may form a side portion of the housing which forms the exterior of the battery assembly 1, and may include a plurality of plate-shaped plates.

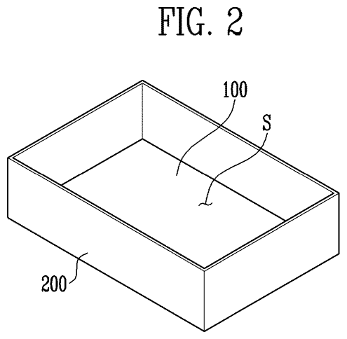

FIG. 2 is a diagram illustrating the bottom plate 100 and the side plate 200 forming a receiving space S.

As shown in FIG. 2, the side plate 200 may be connected to the bottom plate 100 to form the receiving space S together with the bottom plate 100.

The side plate 200 may be formed separately from the bottom plate 100 and coupled to the bottom plate 100. However, the side plate 200 may be formed integrally with the bottom plate 100 to be connected to the bottom plate 100.

Subsequently, the top plate 300 will be described.

Referring to FIG. 1, the top plate 300 may form an upper portion of the housing which forms the exterior of the battery assembly 1, and may be formed in the shape of a plate.

The top plate 300 may be coupled to the side plate 200 to seal the receiving space S.

Furthermore, at least one or more grooves may be formed in one or more of the bottom plate 100, the side plate 200, and the top plate 300 to be engaged with fixing portions 521 of the thermal barrier members 500 to be described below.

Subsequently, the battery cell 400 will be described.

The battery cell 400 may include an electrode assembly and an exterior member which receives the electrode assembly.

The electrode assembly is an assembly of electrode plates with electrode active materials applied thereto and a separator, in which one or more cathode plates and one or more anode plates are disposed between the separator.

An anode plate of the electrode assembly may be provided with an anode tab. One or more anode tabs may be connected to an anode lead. One end of the anode lead may be connected to the anode tab, the other end thereof may be exposed to the outside of the battery cell, and the exposed portion may function as an anode terminal of a secondary cell.

A cathode plate of the electrode assembly is provided with a cathode tab, and one or more cathode tabs may be connected to a cathode lead. One end of the cathode lead is connected to the cathode tab, the other end thereof may be exposed to the outside of the battery cell, and the exposed portion may function as a cathode terminal of the secondary cell.

The exterior member may be formed as a pouch or the like, and depending on the type of exterior member, the battery cell 400 may be formed as a pouch-type secondary cell, a prismatic secondary cell, or the like.

As shown in FIG. 1, the battery cell 400 may be provided as a plurality of battery cells. The plurality of battery cells 400 may be stacked and arranged in a predetermined direction inside the receiving space S.

Subsequently, the thermal barrier member 500 will be described.

The thermal barrier members 500 may each be selectively disposed between adjacent battery cells 400 of the plurality of battery cells 400. The heat barrier member 500 may be disposed in the receiving space S to come into close contact with the bottom plate 100, the side plate 200, and the top plate 300.

Since the thermal barrier member 500 is disposed in close contact with the bottom plate 100, the side plate 200, and the top plate 300 and disposed between a predetermined battery cell 400 and a battery cell adjacent to the predetermined battery cell 400, the gas generated by the thermal runaway of the predetermined battery cell 400 may be blocked by the thermal barrier member 500 from migrating to the battery cell adjacent to the predetermined battery cell 400.

Thus, the transfer of heat by convection of the gas from the battery cell 400 which has undergone thermal runway to the adjacent battery cell 400 may be prevented.

The thermal barrier member 500 may include a first thermal barrier member 510 and a second thermal barrier member 520.

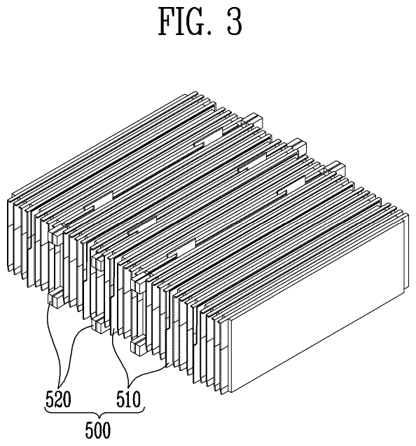

FIG. 3 is a diagram illustrating a plurality of battery cells and a plurality of thermal barrier members.

Referring to FIG. 3, the first thermal barrier member 510 and the second thermal barrier member 520 may be included together in the battery assembly 1. The second thermal barrier member 520 includes the fixing portion 521, unlike the first thermal barrier member 510.

The second thermal barrier member 520 may include a metallic material, or may include a plurality of layers bonded together which may or may not include a metallic material.

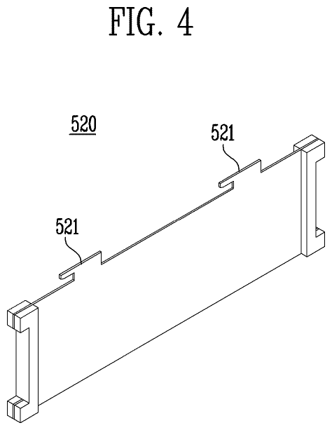

FIG. 4 is a diagram illustrating a thermal barrier member with a fixing portion.

That is, as shown in FIG. 4, at least one of the plurality of thermal barrier members 500 may include the fixing portion 521 which protrudes in a direction facing at least one of the bottom plate 100, the side plate 200, and the top plate 300.

In addition, when the thermal barrier member 500 is disposed in the receiving space S, at least one of the bottom plate 100, the side plate 200, and the top plate 300 adjacent to the fixing portion 521 (hereinafter referred to as an “engagement plate”) may engage with the fixing portion 521 and be prevented from being moved in a direction away from the plurality of thermal barrier members 500 so as to prevent gaps from occurring between at least one plate and the plurality of thermal barrier members 500. The engagement plate may comprise at least one of the bottom plate 100, the side plate 200, and the top plate 300. In the following embodiments, the engagement plate is described as the top plate 300, but this is merely one embodiment and is not limited thereto.

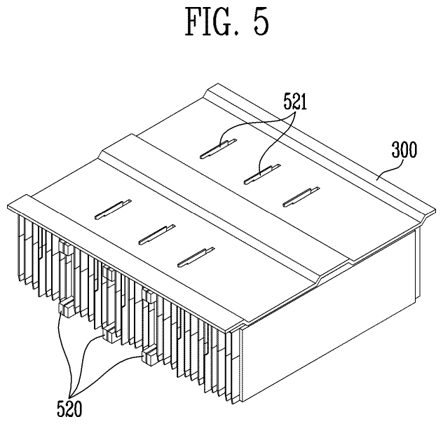

FIG. 5 is a diagram illustrating the top plate 300 engaged with the fixing portions 521 of the thermal barrier members 500.

For example, when an engagement plate is the top plate 300, the top plate 300 may be prevented from being moved in a direction away from the plurality of thermal barrier members 500 by engaging with the fixings portions 521 through grooves formed in the top plate 300, as shown in FIG. 5.

The engagement plate and the fixing portion 521 may be engaged via a variety of structures.

For example, in a structure where the engagement plate and the fixing portion 521 are engaged with each other, the engagement plate is fitted into the groove formed in the fixing portion 521 to engage the engagement plate and the fixing portion 521 with each other.

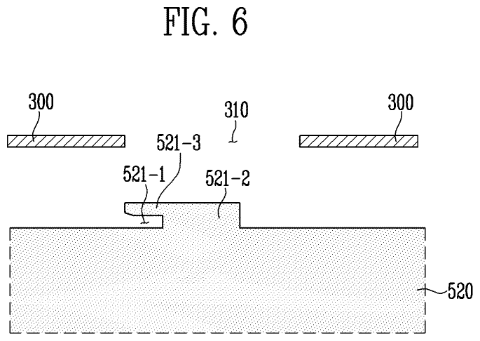

FIG. 6 is a diagram illustrating the top plate 300 and the fixing portion 521 according to one embodiment before engagement.

Specifically, when an engagement plate is the top plate 300, as shown in FIG. 6, the fixing portion 521 has a first groove 521-1 formed in a direction perpendicular to a direction facing the top plate 300, the top plate 300 includes a second groove 310 through which the fixing portion 521 passes, and at least a portion of the engagement plate may be inserted into the first groove 521-1 of the fixing portion 521 passing through the second groove 310.

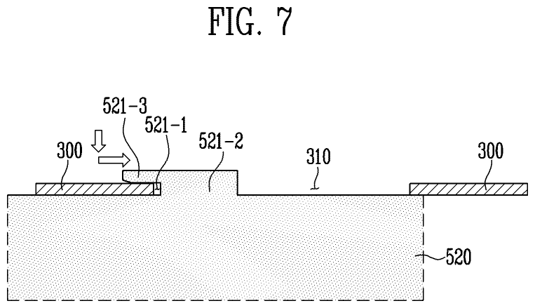

FIG. 7 is a diagram illustrating the top plate 300 and the fixing portion 521 according to one embodiment after engagement.

In addition, as shown in FIG. 7, when the fixing portion 521 penetrates the second groove 310, the top plate 300 slides in a direction toward the first groove 521-1 such that at least a portion of the top plate 300 may be inserted into the first groove 521-1.

The fixing portion 521 may include a first extension 521-2 which extends in a direction toward the top plate 300 and a second extension 521-3 which is connected to one end of the first extension 521-2 and is bent from the first extension 521-2 to form the first groove 521-1 between the first extension 521-2 and the second extension 521-3.

In another example of the structure where the engagement plate and the fixing portion 521 are engaged with each other, one end of the fixing portion 521 which penetrates the engagement plate is bent in a direction facing the engagement plate such that the engagement plate and the fixing portion 521 may be engaged with each other.

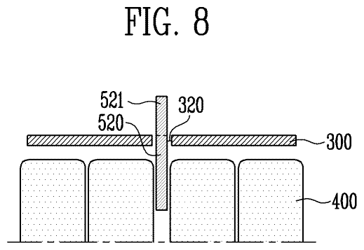

FIG. 8 is a diagram illustrating the top plate 300 and the fixing portion 521 according to another embodiment before engagement.

Specifically, when an engagement plate is the top plate 300, as shown in FIG. 8, the top plate 300 may include a third groove 320 through which the fixing portion 521 passes, and one end of the fixing portion 521 may penetrate the third groove 320.

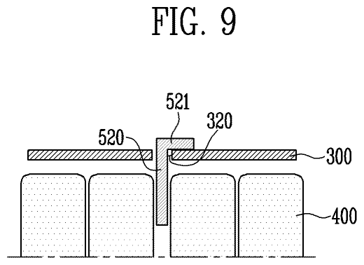

FIG. 9 is a diagram illustrating the top plate 300 and the fixing portion 521 according to another embodiment after engagement.

In addition, as shown in FIG. 9, after the fixing portion 521 penetrates the third groove 320, at least a portion of the fixing portion 521 may be bent to come into contact with the top plate 300.

The fixing portion 521 may include a bendable material and may be bent to come into contact with the top plate 300. However, the fixing portion 521 may also include a third extension extending in a direction toward the top plate 300 and a fourth extension rotatably coupled to one end of the third extension, and fixed in position when the fourth extension is rotated from the one end of the third extension to come into contact with the top plate 300.

In other words, the fixing portion 521 may have a structure in which a portion thereof rotationally moves and is then fixed in position.

In another example of the structure where the engagement plate and the fixing portion 521 are engaged with each other, one end of the fixing portion 521 which penetrates a recessed portion in the engagement plate is bent in a direction facing the recessed portion of the engagement plate so that the engagement plate and the fixing portion 521 may be engaged with each other.

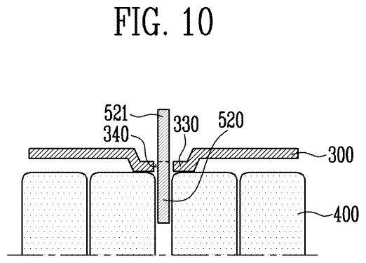

FIG. 10 is a diagram illustrating the top plate 300 with a recessed portion 330 and the fixing portion 521 before engagement.

Specifically, when an engagement plate is the top plate 300, as shown in FIG. 10, the top plate 300 includes a fourth groove 340 through which the fixing portion 521 passes and the recessed portion 330 which is recessed toward the second thermal barrier member 520, and one end of the fixing portion 521 may penetrate the fourth groove 340.

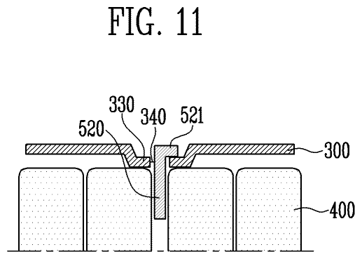

FIG. 11 is a diagram illustrating the top plate 300 and the fixing portion 521 after engagement.

In addition, as shown in FIG. 11, after the fixing portion 521 penetrates the fourth groove 340, at least a portion of the fixing portion 521 may be bent to come into contact with the recessed portion 330.

The fixing portion 521 may include a bendable material and may be bent to come into contact with the recessed portion 330. However, the fixing portion 521 may further include a fifth extension extending in a direction toward the recessed portion 330 and a sixth extension rotatably coupled to one end of the fifth extension, and fixed in position when the sixth extension is rotated from the one end of the fifth extension to come into contact with the recessed portion 330.

That is, the fixing portion 521 may have a structure in which a portion thereof rotationally moves and is then fixed in position.

In this manner, when the recessed portion 330 is formed in the engagement plate and the fixing portion 521 is bent to come into contact with the recessed portion 330, the bent fixing portion 521 is partially received in the recessed portion 330 to prevent the fixing portion 521 from protruding outside of the battery assembly 1, thereby preventing an increase in the volume of the space occupied by the battery assembly 1.

Subsequently, the busbar assembly 600 will be described.

As described with reference to FIG. 1, the busbar assembly 600 may include at least one busbar configured to electrically connect the plurality of battery cells 400 and a busbar frame configured to externally mount the busbar.

As shown in FIG. 1, the busbar assemblies 600 may be housed in the receiving space S and oppose each other with the plurality of stacked battery cells 400 interposed therebetween so as to be electrically connected to the plurality of battery cells 600.

Hereinafter, the operation of the battery assembly according to one embodiment of the present disclosure will be described.

The plurality of battery cells 400 and the busbar assembly 600 are placed in the receiving space S defined by the bottom plate 100 and the side plate 200 of the battery assembly 1.

The thermal barrier members 500 may each be selectively disposed between adjacent battery cells 400 of the plurality of battery cells 400.

Subsequently, the top plate 300 is coupled to the side plate 200 so as to seal the receiving space S.

The thermal barrier member 500 having the fixing portion 521 may be engaged with the engagement plate of at least one of the bottom plate 100, the side plate 200, and the top plate 300 adjacent to the fixing portion 521.

In this manner, as the fixing portion 521 is engaged with the engagement plate, the engagement plate may be prevented from moving in a direction away from the plurality of thermal barrier members 500, and a gap between the engagement plate and the thermal barrier members 500 may be prevented from occurring.

Hereinafter, a method of manufacturing a battery assembly according to one embodiment of the present disclosure will be described.

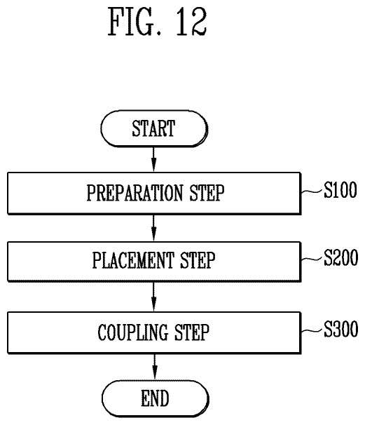

FIG. 12 is a flowchart for illustrating a method of manufacturing a battery assembly according to one embodiment of the present disclosure.

Referring to FIG. 12, the method of manufacturing the battery assembly includes a preparation step S100, a placement step S200, and a coupling step S300, and the battery assembly manufactured by the manufacturing method may be the same as the battery assembly 1 according to one embodiment of the present disclosure.

First, the preparation step S100 will be described.

The preparation step S100 is a step of preparing the bottom plate 100, the side plate 200 which is connected to the bottom plate 100 to form the receiving space S together with the bottom plate 100, and the top plate 300.

The configurations of the bottom plate 100, the side plate 200, and the top plate 300 prepared in the preparation step S100 may be the same as those of the bottom plate 100, the side plate 200, and the top plate 300 of the battery assembly 1 according to one embodiment of the present disclosure.

Subsequently, the placement step S200 will be described.

The placement step S200 is a step of placing the components of the battery assembly 1 in the receiving space S. The components of the battery assembly 1 may include the plurality of battery cells 400 stacked in a predetermined direction, and the plurality of thermal barrier members 500 each selectively disposed between adjacent battery cells 400 of the plurality of battery cells 400 and disposed in the receiving space S to come into close contact with the bottom plate 100, the side plate 200, and the top plate 300.

The configurations of the battery cells 400 and the thermal barrier members 500 may be the same as those of the battery cells 400 and the thermal barrier members 500 of the battery assembly 1 according to one embodiment of the present disclosure.

In addition, the components of the battery assembly 1 may include the busbar assembly 600 of the battery assembly 1 according to one embodiment of the present disclosure.

Subsequently, the coupling step S300 will be described.

The coupling step S300 is a step of coupling the top plate 300 to the side plate 200 so as to seal the receiving space S.

In the battery assembly manufactured by the manufacturing method, an engagement plate may be prevented from moving in a direction away from the thermal barrier members 500 in the same manner as the battery assembly 1 according to one embodiment of the present disclosure.

That is, at least one of the plurality of thermal barrier members 500 may include the fixing portion 521 which projects in a direction toward at least one of the bottom plate 100, the side plate 200, and the top plate 300.

In addition, the engagement plate of at least one of the bottom plate 100, the side plate 200, and the top plate 300 adjacent to the fixing portion 521 may be engaged with the fixing portion 521 and prevented from being moved in a direction away from the plurality of thermal barrier members 500 so as to prevent a gap between the plurality of thermal barrier members 500 from occurring.

The engagement plate and the fixing portion 521 may be engaged via a variety of structures.

For example, in a structure where the engagement plate and the fixing portion 521 are engaged with each other, the engagement plate is fitted into a groove formed in the fixing portion 521 to engage the engagement plate and the fixing portion 521 with each other.

Specifically, when the engagement plate is the top plate 300, as shown in FIG. 6, the fixing portion 521 may have the first groove 521-1 formed in a direction perpendicular to a direction facing the top plate 300, and the top plate 300 may include the second groove 310 through which the fixing portion 521 passes. At least a portion of the fixing portion 521 penetrating the second groove 310 may be inserted into the first groove 521-1 of the fixing portion 521.

In addition, as shown in FIG. 7, when the fixing portion 521 penetrates the second groove 310, the top plate 300 slides in a direction toward the first groove 521-1 and is at least partially inserted into the first groove 521-1.

The fixing portion 521 may include the first extension 521-2 which extends in a direction toward the top plate 300 and the second extension 521-3 which is connected to one end of the first extension 521-2 and is bent from the first extension 521-2 to form the first groove 521-1 between the first extension 521-2 and the second extension 521-3.

In another example of the structure where the engagement plate and the fixing portion 521 are engaged with each other, one end of the fixing portion 521 which penetrates the engagement plate is bent in a direction facing the engagement plate such that the engagement plate and the fixing portion 521 may be engaged with each other.

Specifically, when the engagement plate is the top plate 300, as shown in FIG. 8, the top plate 300 may be formed with the third groove 320 through which the fixing portion 521 passes, and the one end of the fixing portion 521 may penetrate the third groove 320.

In addition, as shown in FIG. 9, after the fixing portion 521 penetrates the third groove 320, at least a portion of the fixing portion 521 may be bent to come into contact with the top plate 300.

The fixing portion 521 may include a bendable material and may be bent to come into contact with the top plate 300. However, the fixing portion 521 may also include a third extension extending in a direction toward the top plate 300 and a fourth extension rotatably coupled to one end of the third extension, and fixed in position when the fourth extension is rotated from the one end of the third extension to come into contact with the top plate 300.

In other words, the fixing portion 521 may have a structure in which a portion thereof rotationally moves and is then fixed in position.

In another example of the structure where the engagement plate and the fixing portion 521 are engaged with each other, one end of the fixing portion 521 which penetrates a recessed portion in the engagement plate is bent in a direction facing the recessed portion in the engagement plate so that the engagement plate and the fixing portion 521 may be engaged with each other.

Specifically, when the engagement plate is the top plate 300, as shown in FIG. 10, the top plate 300 includes the fourth groove 340 through which the fixing portion 521 passes, and the recessed portion 330 which is recessed toward the second thermal barrier member 520, and one end of the fixing portion 521 may penetrate the fourth groove 340.

In addition, as shown in FIG. 11, after the fixing portion 521 penetrates the fourth recessed portion 340, at least a portion of the fixing portion 521 may be bent to come into contact with the recessed portion 330.

The fixing portion 521 may include a bendable material and may be bent to come into contact with the recessed portion 330. However, the fixing portion 521 may also include a fifth extension extending in a direction toward the recessed portion 330 and a sixth extension rotatably coupled to one end of the fifth extension, and fixed in position when the sixth extension is rotated from the one end of the fifth extension to come into contact with the recessed portion 330.

In other words, the fixing portion 521 may have a structure in which a portion thereof rotationally moves and is then fixed in position.

In this manner, when the recessed portion 330 is formed in the engagement plate and the fixing portion 521 is bent to come into contact with the recessed portion 330, a portion of the bent fixing portion 521 is received in the recessed portion 330 to prevent the fixing portion 521 from protruding outside of the battery assembly 1, thereby preventing an increase in the volume of the space occupied by the battery assembly 1.

As described above, according to the present disclosure, in the battery assembly according to the present disclosure and the manufacturing method thereof, the bottom plate, the side plate, and the top plate are configured to engage with the fixing portion of the thermal barrier member so as to be prevented from being moved in a direction away from the thermal barrier member, so that when a battery cell accommodated in the battery assembly undergoes thermal runaway, gas generated from the battery cell is prevented from being transferred to other adjacent battery cells.

In addition, since the thermal barrier member is configured to prevent the positions of the bottom plate, the side plate, and the top plate from changing by using the fixing portion formed on the thermal barrier member, the bottom plate, the side plate, and the top plate may have a relatively small thickness, thereby reducing the weight of the battery assembly.

The foregoing description of the present disclosure is intended for illustrative purposes only and is not intended to limit the disclosure. It will be understood by those skilled in the art that various modifications, substitutions, and alterations may be made without departing from the spirit and scope of the present disclosure. For instance, components described as being implemented in a singular form may be implemented in a distributed manner, and likewise, components described as being distributed may be implemented in a combined or integrated form.

The scope of the present disclosure is defined by the following claims rather than the foregoing detailed description, and all variations or modifications within the meaning and scope of the claims, and equivalents thereof, are to be construed as falling within the scope of the present disclosure.

What is claimed is:

1. A battery assembly, comprising:
a bottom plate;
a side plate connected to the bottom plate to form a receiving space with the bottom plate;
a plurality of battery cells stacked and disposed in a predetermined direction in the receiving space;
a top plate coupled to the side plate to seal the receiving space; and
a plurality of thermal barrier members each selectively disposed between adjacent battery cells of the plurality of battery cells and disposed in the receiving space to come into close contact with the bottom plate, the side plate, and the top plate,
wherein at least one of the plurality of thermal barrier members comprises a fixing portion projecting in a direction toward at least one of the bottom plate, the side plate, and the top plate, and
wherein an engagement plate of at least one of the bottom plate, the side plate, and the top plate adjacent to the fixing portion engages with the fixing portion and is prevented from being moved in a direction away from the plurality of thermal barrier members such that a gap between the engagement plate and the plurality of thermal barrier members is prevented from occurring.

2. The battery assembly of claim 1, wherein a first groove is provided in the fixing portion in a direction perpendicular to a direction facing the engagement plate, and
wherein a second groove is provided in the engagement plate and at least a portion of the engagement plate is inserted into the first groove of the fixing portion penetrating the second groove.

3. The battery assembly of claim 2, wherein the fixing portion comprises:
a first extension extending in a direction toward the engagement plate; and
a second extension connected to one end of the first extension and bent from the first extension to form the first groove between the first extension and the second extension, and
wherein when the fixing portion penetrates the second groove, the engagement plate slides in a direction toward the first groove such that at least a portion of the engagement plate is inserted into the first groove.

4. The battery assembly of claim 1, wherein a third groove through which the fixing portion passes is provided in the engagement plate, and
wherein after the fixing portion penetrates the third groove, at least a portion of the fixing portion is bent to come into contact with the engagement plate.

5. The battery assembly of claim 4, wherein the fixing portion comprises:
a third extension extending in a direction toward the engagement plate; and
a fourth extension rotatably coupled to one end of the third extension, and fixed in position when the fourth extension is rotated from the one end of the third extension to come into contact with the engagement plate.

6. The battery assembly of claim 1, wherein the engagement plate comprises a recessed portion where a fourth groove through which the fixing portion passes is formed, the recessed portion recessed in a direction toward the thermal barrier member, and
wherein after the fixing portion penetrates the fourth groove, at least a portion of the fixing portion is bent to come into contact with the recessed portion.

7. The battery assembly of claim 6, wherein the fixing portion comprises:
a fifth extension extending in a direction toward the recessed portion; and
a sixth extension rotatably coupled to one end of the fifth extension, and fixed in position when the sixth extension is rotated from the one end of the fifth extension to come into contact with the recessed portion.

8. A method of manufacturing a battery assembly, the method comprising:
preparing a bottom plate, a side plate connected to the bottom plate to form a receiving space with the bottom plate, and a top plate;
placing components of the battery assembly in the receiving space, the components including a plurality of battery cells stacked in a predetermined direction and a plurality of thermal barrier members each selectively disposed between adjacent battery cells of the plurality of battery cells, and disposed in the receiving space to come into close contact with the bottom plate, the side plate, and the top plate; and
coupling the top plate to the side plate to seal the receiving space,
wherein at least one of the plurality of thermal barrier members comprises a fixing portion projecting in a direction toward at least one of the bottom plate, the side plate, and the top plate, and
wherein an engagement plate of at least one of the bottom plate, the side plate, and the top plate adjacent to the fixing portion engages with the fixing portion and is prevented from being moved in a direction away from the plurality of thermal barrier members such that a gap between the engagement plate and the plurality of thermal barrier members is prevented from occurring.

9. The method of claim 8, wherein a first groove is formed in the fixing portion in a direction perpendicular to a direction facing the engagement plate, and
wherein a second groove through which the fixing portion passes is formed in the engagement plate, and at least a portion of the fixing portion is inserted into the first groove of the fixing portion penetrating the second groove.

10. The method of claim 9, wherein the fixing portion comprises:
a first extension extending in a direction toward the engagement plate; and
a second extension connected to one end of the first extension, and bent from the first extension to form the first groove between the first extension and the second extension, and
wherein the engagement plate slides in a direction toward the first groove such that at least a portion thereof is inserted into the first groove when the fixing portion penetrates the second groove.

11. The method of claim 8, wherein a third groove through which the fixing portion passes is formed in the engagement plate, and
wherein after the fixing portion penetrates the third groove, at least a portion of the fixing portion is bent to come into contact with the engagement plate.

12. The method of claim 11, wherein the fixing portion comprises:
a third extension extending in a direction toward the engagement plate; and
a fourth extension rotatably coupled to one end of the third extension, and fixed in position when the fourth extension is rotated from the one end of the third extension to come into contact with the engagement plate.

13. The method of claim 8, wherein a fourth groove through which the fixing portion passes is formed in the engagement plate in a direction facing the thermal barrier member, and
wherein after the fixing portion penetrates the fourth groove, at least a portion of the fixing portion is bent to come into contact with the recessed portion.

14. The method of claim 13, wherein the fixing portion comprises:
a fifth extension extending in a direction toward the recessed portion; and
a sixth extension rotatably coupled to one end of the fifth extension, and fixed in position when the sixth extension is rotated from the one end of the fifth extension to come into contact with the recessed portion.
